(19) United States
(12) Patent Application Publication
(10) Pub. No.: US 2004/0075890 A1
(43) Pub. Date: Apr. 22, 2004

(54) Optical signal processing element using saturable absorber and optical amplifier

(76) Inventors: Hyun Soo Kim, Daejon-Shi (KR); Jong Hoi Kim, Daejon-Shi (KR); Eun Deok Sim, Daejon-Shi (KR); Kang Ho Kim, Daejon-Shi (KR); Oh Kee Kwon, Anyang-Shi (KR); Kwang Ryong Oh, Daejon-Shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/668,809

(22) Filed: Sep. 22, 2003

(30) Foreign Application Priority Data
Oct. 18, 2002 (KR) 2002-63662

(51) Int. Cl. H01S 3/00

(52) U.S. Cl. 359/341.1

(57) ABSTRACT

The present invention relates to an optical signal processing element capable of performing various functions of equalization of output power, wavelength converting, reshaping or reamplifying an input optical signal using an optical amplifier in which saturable absorbers are integrated, the saturable absorbers being used as an optical gate to improve the extinction ratio of the input optical signal. The saturable absorber and the optical amplifier are connected in series, and a transparent output optical power outputted from the saturable absorber is not less than a saturation input optical power of the optical amplifier.

### BACKGROUND OF THE INVENTION

1. Field of the Invention:

The present invention relates to an optical signal processing element used as a key part of a wavelength division multiplexing optical transmission and switching system, and more particularly to an optical signal processing element capable of performing various functions of equalization of output power, wavelength converting, reshaping and reamplifying an input optical signal using an optical amplifier in which saturable absorbers are integrated, the saturable absorber is used as an optical gate to improve an extinction ratio of the input optical signal.

2. Description of the Prior Art:

Generally, the saturable absorber has been often used in a pulse laser such as a mode locking laser diode disclosed in IEE Electron. Lett., 26, 1087 (1990) by S. Sanders et al., and is recently adapted for a noise elimination disclosed in CLEO, 329 (2000) by Z. Bakonyi et al. and an optical discrimination disclosed in IEE Electron. Lett., 34, 198 (1998) by A. Hirano et al.

The optical amplifier amplifies the input optical signal by a gain of the optical amplifier to output the amplified optical signal, using the gain characteristic of semiconductor. A semiconductor optical amplifier (SOA) directly amplifies the optical signal without any conversion into the electrical signal. The semiconductor optical amplifier is constructed to have a structure similar to a semiconductor laser using compound semiconductor materials, and both sides of the semiconductor optical amplifier are subjected to a anti-reflection thin film processing, so that the semiconductor optical amplifier can amplify a week input optical signal. The semiconductor optical amplifier can amplify the optical signal with a high gain over a wide wavelength range available in an optical communication system of 1.55 μm wavelength band. The semiconductor optical amplifier is much smaller than a conventional erbium-doped amplifier (EDFA), and thus can be monolithically integrated with other semiconductor optical element and a passive waveguide. Accordingly, the semiconductor optical amplifier is widely used in application fields including a wavelength converter, an optical switch, a logical element and so on.

Now, a conventional optical signal processing element for performing a wavelength conversion using the optical amplifier will be described. The capacity of an optical communication system based on the wavelength division multiplexing (WDM) method is generally restricted by the number of channels to be used. In order to alleviate this restriction and increase a flexibility of the system, a wavelength conversion using the semiconductor optical amplifier has been proposed. In the conventional wavelength conversion, a cross-gain modulation (XGM) method using gain exchange between channels and a cross-phase modulation (XPM) method using phase variation of light in the semiconductor optical amplifier are widely used.

Since the cross-gain modulation (XGM) method uses a gain saturation of the semiconductor optical amplifier, there have been problems that a power of the input optical signal should be high and a converted signal has been inverted with respect to an original signal.

FIGS. 1A and 1b are views illustrating the conventional XGM type wavelength converter. As shown in FIGS. 1A and 1B, a gain of the optical amplifier 300 is varied depending on the modulated input optical signal having a wavelength λₛ. A continuous wave signal having a desired wavelength λ_{c} is gain-modulated due to the gain saturation. A filter 310 selects only an optical signal having the desired wavelength λ_{c}. As a result, the output optical signal having a desired wavelength λ_{c} includes the information of the modulated input optical signal having λₛ. Here, since the input optical signal is propagated to the continuous wave signal due to the gain saturation, the output optical signal is inverted between a high level and a low level. FIG. 1A shows a case that the continuous wave signal and the optical signal are co-propagated, and FIG. 1B shows a case that the continuous wave signal and the optical signal are counter-propagated.

The XPM method has a configuration that the semiconductor optical amplifier and the passive waveguide are formed on the same substrate, to convert the wavelength by using changes of the refraction index of medium due to interference between the input optical signal and a pumped optical signal. FIG. 1C schematically shows a configuration of the conventional XPM wavelength converter.

The XPM method uses the phase variation of the continuous wave signal depending on the power of the input optical signal under the gain saturated condition of the semiconductor optical amplifier 500, 520. The continuous wave signal is coupled in the Mach-Zehnder interferometer and split equally to the each interferometer arm in a 3 dB Y-branch. The continuous wave is recombined and interferes at Y-combiner either constructively or destructively depending on the bias currents of semiconductor optical amplifier as well as the optical power of the modulated input signal. Also, the output optical signal may be inverted or non-inverted depending on the power of the input optical signal.

However, in the XPM method, since the power of the output optical signal is varied depending on the power of the input optical signal, there has been a problem that the input optical power dynamic range is very restricted.

### SUMMARY OF INVENTION

It is therefore an object of the present invention to provide a new optical signal processing element in which a saturable absorber and a semiconductor optical amplifier are integrated to be capable of amplifying an optical signal, eliminating a noise, increasing an output optical power, improving an extinction ratio, and performing various functions of equalization of output power, wavelength converting, reshaping and reamplifying the output optical signal.

It is another object of the present invention to provide an optical signal processing element which can easily perform a non-inverted wavelength conversion and of which an input optical power dynamic range is relatively wide.

In order to accomplish the above objects, the present invention provides an optical signal processing element comprising: a first saturable absorber of which an passing power is more than a absorbed power thereof if an input optical signal having a power higher than a transparent input optical power is inputted, and of which the absorbed power is more than the passing power thereof if an input optical signal having a power lower than the transparent input optical power is inputted; and an optical amplifier connected in series to the first saturable absorber and exhibiting an optical saturation when a power is not less than a saturation input optical power; wherein a transparent output optical power outputted from the first saturable absorber is not less than the saturation input optical power.

Furthermore, the optical signal processing element of the present invention is further comprising a second saturable absorber connected to an output terminal of the optical amplifier. In this case, preferably, the transparent input optical power of the first saturable absorber is higher than a transparent input optical power of the second saturable absorber.

Furthermore, the optical signal processing element of the present invention, wherein the first saturable absorber and the optical amplifier are formed on a substrate, the element further comprising: the substrate; a first cladding layer formed on the substrate; an active layer formed on the first cladding layer; a second cladding layer formed on the active layer; dielectrics formed on both longitudinal facets; an upper electrode formed on an upper surface above the first cladding layer, the second cladding layer and the active layer; and an lower electrode formed on a lower surface below the first cladding layer, the second cladding layer and the active layer; wherein, the upper electrode is divided correspondingly to the first saturable absorber and the optical amplifier, and the lower electrode is formed in a body, to connect the first saturable absorber and the optical amplifier in series.

Preferably, the active layer comprised InGaAsP group triple layers including a fist layer made of a quaternary compound of 1.24 μm bandgap, a second layer made of a quaternary compound of 1.55 μm bandgap and formed on the first layer and a third layer made of a quaternary compound of 1.24 μm bandgap and formed on the second layer,

Furthermore, the optical signal processing element of the present invention can further comprises a filter at an output end of the optical amplifier, wherein the total power of the optical signal and a continuous wave signal having a desired wavelength lower than the transparent input optical power is not less than the transparent input optical power. Thus, a wavelength converter can be realized by converting a wavelength of an optical signal into a desired wavelength using the optical saturable absorber, the optical amplifier and the filter.

### BRIEF DESCRIPTION OF DRAWINGS

The above and other objects, advantages and features of the present invention will become apparent from the following description of preferred embodiments given in conjunction with the accompanying drawings, in which:

FIGS. 1A, 1B and 1C are views illustrating conventional wavelength converter;

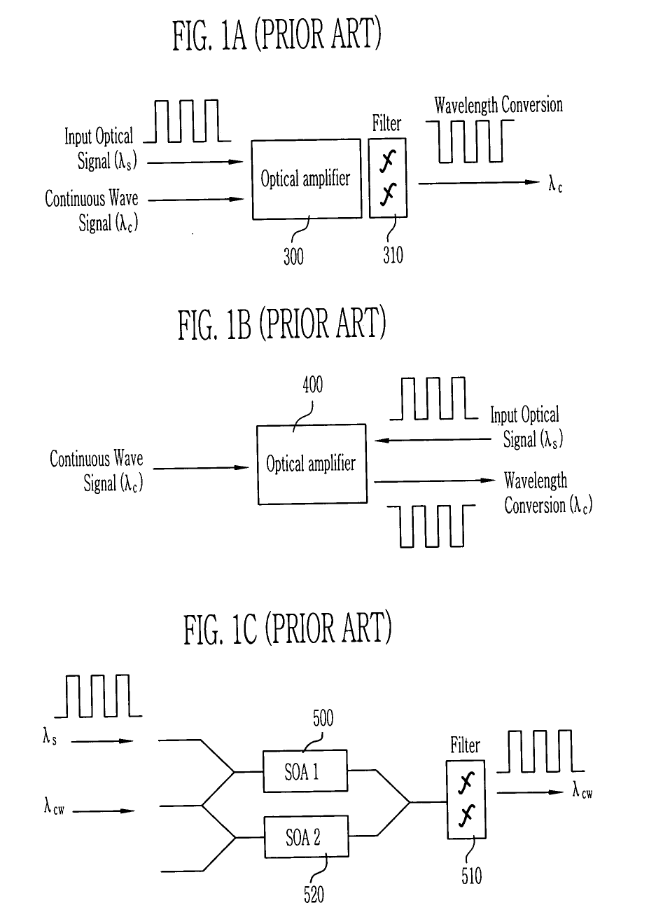

FIG. 2 is a constructional view illustrating an optical signal processing element according to an embodiment of the present invention;

FIG. 3 is a longitudinal view illustrating an example of manufacturing the optical signal processing element in FIG. 2;

FIGS. 4A to 4D are conceptional views illustrating functions of the optical signal processing element in FIG. 2;

FIG. 5 is a constructional view illustrating an optical signal processing element according to another embodiment of the present invention;

FIG. 6 is a constructional view illustrating a wavelength converter employing a saturable absorber integrated optical amplifier according to a preferred embodiment of the present invention; and

FIGS. 7A to 7F are conceptional views illustrating an operational principle of the wavelength converter in FIG. 6.

### DETAILED DESCRIPTION OF THE PERFERED EMGODIMENTS

Now, the embodiments according to the present invention will be described in detail with references to the appended drawings. However, various changes and modifications may be made to the embodiments, and thus it is believed that the present invention is not limited to the embodiments described below. The embodiments will be provided for more complete explanation of the present invention to those skilled in the art.

(First Embodiment)

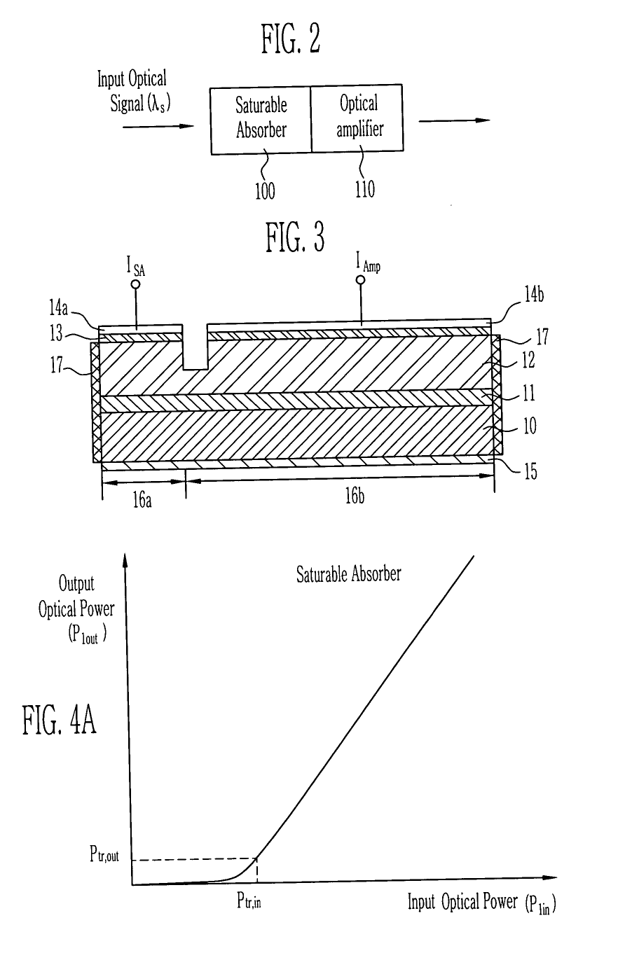

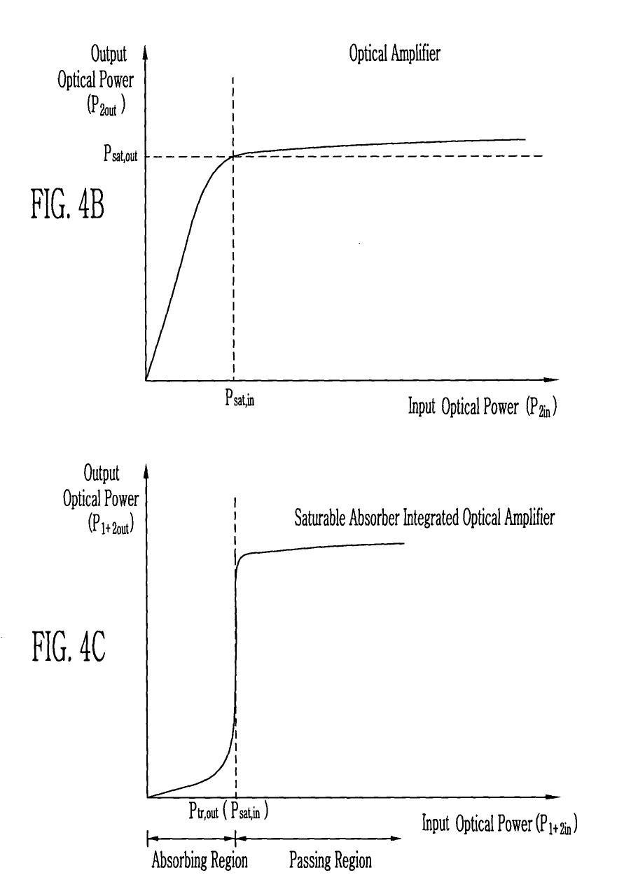

FIG. 2 is a constructional view illustrating an optical signal processing element according to a preferred embodiment of the present invention. The optical signal processing element comprises a saturable absorber 100 and an optical amplifier 110. FIG. 3 is a longitudinal view illustrating an example of modulating the optical signal processing element in FIG. 2.

Referring to FIG. 3, the optical signal processing element comprises a saturable absorber area 16a and an optical amplifier area 16b. Upper metal electrodes 14a, 14b are electrically disconnected correspondingly to the saturable absorber area 16a and the optical amplifier area 16b, respectively, and a lower metal electrode 15 is formed all over the saturable absorber area 16a and the optical amplifier area 16b. That is, the optical signal processing element comprises a undoped-doped InGaAsP group active layer 11, a p-doped InP cladding layer 12, an InGaAs ohmic contact layer 13, the upper metal electrodes 14a, 14b, the lower metal electrodes 15 and dielectrics 17. The dielectrics 17 are disposed as anti-reflecting films on both sides of the optical signal processing element so as to increase the gain of the optical amplifier and to suppress the Fabry-Perot resonant mode. The dielectrics 17 may include, for example, TiO₂/SiO₂ thin films. The electrical disconnection of the upper metal electrodes 14a, 14b are carried out by separating the saturable absorber area 16a and the optical amplifier area 16b using a conventional photo-lithography process.

The InGaAsP active layer 11 can comprises three layers. A first layer made of a quaternary compound having a 1.24 μm bandgap is form to be 0.1 μm thick, a second layer made of a quaternary compound having a 1.55 μm bandgap is formed on the first layer to be 0.15 μm thick, and a third layer made of a quaternary compound having a 1.24 μm bandgap is formed on the second layer to be 0.1 μm thick.

On the other hand, a current I_{Amp} applied to the optical amplifier is lower than a threshold current to suppress the Fabry-Perot resonant mode, and current I_{SA} applied to the saturable absorber is set such that the transparent output optical power of the saturable absorber is equal to or higher than the saturation input optical power of the optical amplifier. This will be described in detail later.

On the other hand, when impurities are implanted into the saturable absorber 16a using an ion-implanter, life cycles of carriers generated by the absorbed light are reduced and thus the high-speed operation is possible.

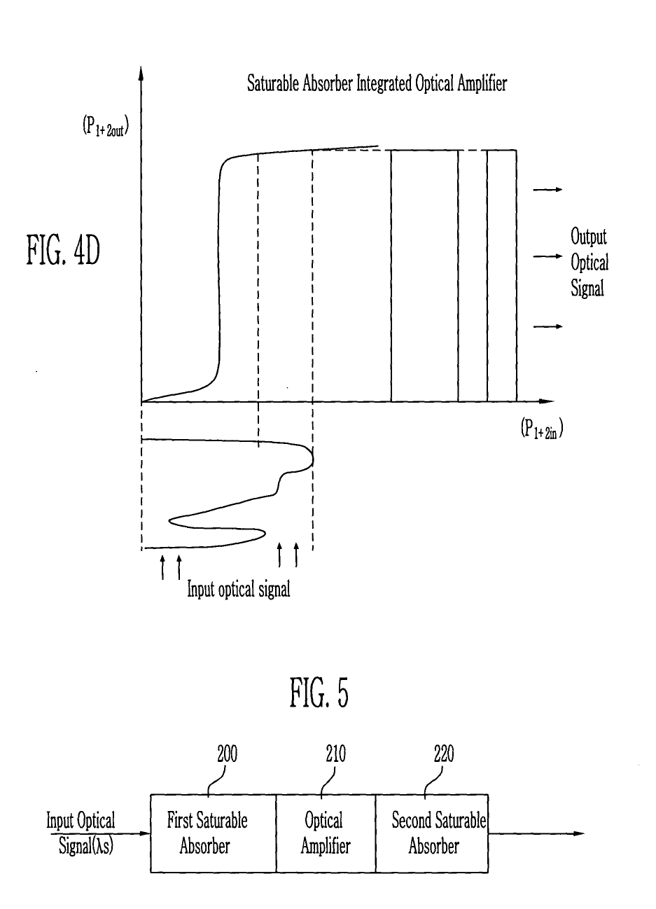

Now, operations of the optical signal processing element will be described width reference to FIGS. 4A to 4D.

Referring to FIG. 4A, if the input optical signals having a power lower than the transparent input optical power P_{tr, in} are inputted to the saturable absorber, the saturable absorber absorbs most of the input optical signals, and thus the output optical power P₁ₒᵤₜ thereof is low. If the input optical signals having a power higher than the transparent input optical power P_{tr, in} are inputted to the saturable absorber, most of the input optical signals are outputted. Thus, when optical signals including noises are inputted to the saturable absorber, the noises can be eliminated by adjusting the power of the noises to be less than the transparent input optical power P_{tr, in} of the saturable absorber.

Referring to FIG. 4B, if the input optical signals having a power less than the saturation input optical power P_{sat, in} are inputted to the optical amplifier, the input optical signals are amplified by a gain of the optical amplifier. If the input optical signals having a power higher than the saturation input optical power P_{sat, in} are inputted to the optical amplifier, the output optical power P₂ₒᵤₜ is saturated and outputted.

FIG. 4C is a graph illustrating variation of the output optical power according to the input optical power when the transparent output optical power (P_{tr, out} in FIG. 4A) of the saturable absorber and the saturation input optical power (P_{sat, in} in FIG. 4B) of the optical amplifier are made to be equal to each other. Since the noises having the power lower than the transparent input optical power P_{tr, in} of the saturable absorber are absorbed by the saturable absorber, the noises are removed (absorbing region). Also, if the input optical signals having the power higher than the transparent input optical power P_{tr, in} of the saturable absorber are inputted, the input optical signals pass through the saturable absorber without substantial loss. The optical signals passing through the saturable absorber are amplified by the optical amplifier up to the saturation output optical power, and the amplified optical signals having a constant power are outputted.

FIG. 4D is a view illustrating an example of the waveform of the output optical power corresponding to the input optical power when the transparent output optical power (P_{tr, out} in FIG. 4A) of the saturable and saturation input optical power (P_{sat, in} in FIG. 4B) of the optional amplifier are made to be equal to each other. As shown in FIG. 4D, it can be known that by using the optical signal processing element according to the embodiment of the present invention, the output power of optical signals having different powers are kept constant, the noises are eliminated, and the extinction ratio is increased. In addition, it can be known that the reshaping and the reamplifying (2R) are performed when the optical signals have a time jitter. That is, it can be known that the time jitter is largely reduced by using the optical signal processing element.

On the other hand, although in FIG. 4C, it has been described that the transparent output optical power (P_{tr, out} in FIG. 4A) of the saturable absorber and the saturation input optical power (P_{sat, in} in FIG. 4B) are made to be equal to each other, it is possible to obtain the same effect even when the transparent output optical power is higher than the saturation input optical power.

(Second Embodiment)

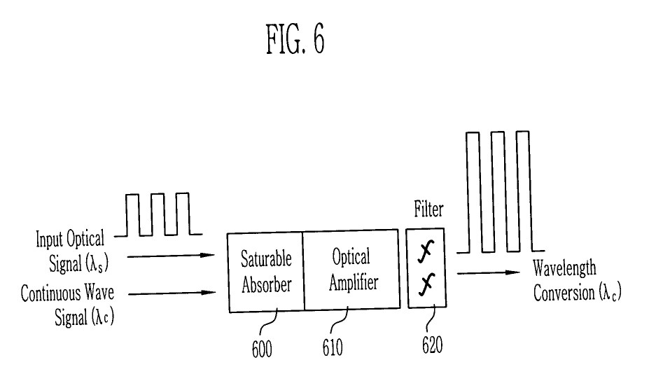

Now, a second embodiment of the present invention will be described with reference to FIG. 5. FIG. 5 is a constructional view of the optical signal element according to the second embodiment of the present invention. According to the second embodiment of the present invention, as shown in FIG. 5, saturable absorbers 200, 220 may be integrated at both ends of the semiconductor optical amplifier 210. By means of this configuration, it is possible to minimize the noise by reducing the amplified spontaneous emission (ASE) noise generated in the optical signal processing element. In this case, it is preferable that the transparent output optical power of the first saturable absorber 200 is higher than the saturation input optical power of the optical amplifier, and the transparent input optical power of the second saturable absorber 220 is lower than the transparent input optical power of the first saturable absorber 200.

(Third Embodiment)

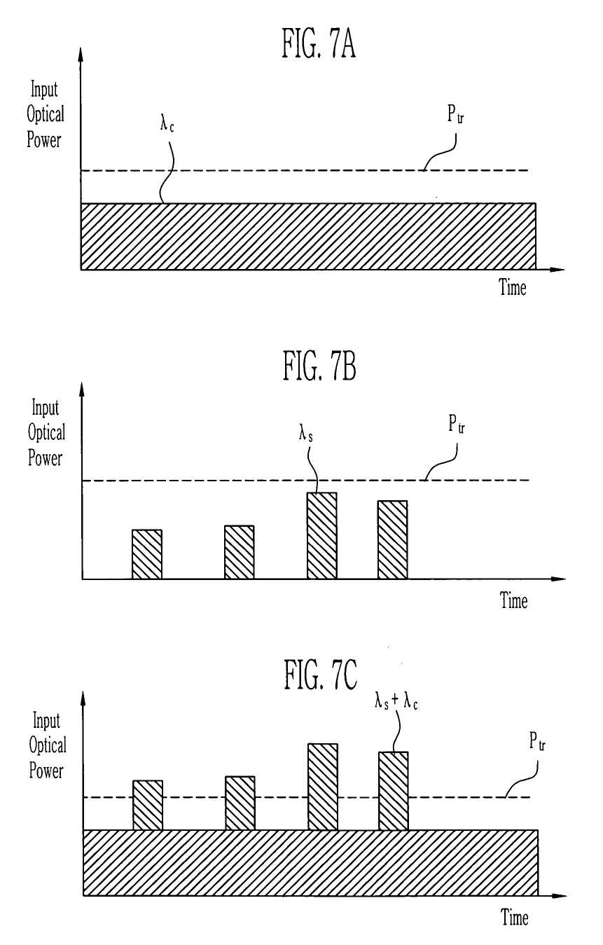

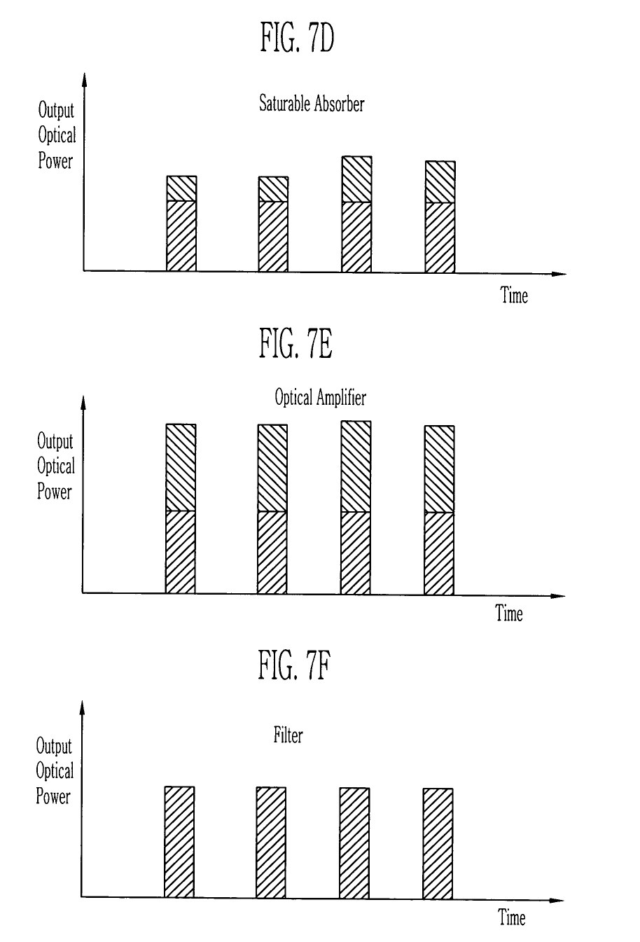

Now, a third embodiment of the present invention will be described with reference to FIGS. 6 and 7.

FIG. 6 is a constructional view of the wavelength converter fabricated using the saturable absorber integrated optical amplifier. The wavelength converter according to this embodiment comprises a saturable absorber 600, an optical amplifier 610 and a filter 620. Now, the operational principle of the wavelength converter will be described with reference to the FIGS. 7A˜7F. In FIG. 7A, λ_{c} indicates a desired wavelength of the continuous wave, and Pₜᵣ indicates the transparent input optical power of the saturable absorber. In FIG. 7B, λₛ is indicates the modulated input optical signal. In this case, when both of the modulated input optical signal having the wavelength λₛ and the continuous wave signal having the desired wavelength λ_{c} are inputted to the saturable absorber, the modulated input optical signal can pass through the saturable absorber only in the case that the total power of the input optical signal and the continuous wave signal is higher than the transparent input optical power Pₜᵣ. That is, FIG. 7C is a view illustrating a case that the input optical signal can pass through the saturable absorber only in the case that the total power of the modulated input optical signal having the wavelength λₛ and the continuous wave signal having the desired wavelength λ_{c} is higher than the transparent input optical power Pₜᵣ.

Next, referring to the FIG. 7D, the output optical power of the input optical signal after passing though the saturable absorber 600 is illustrated. In addition, referring to the FIG. 7E, the optical signal passing through the saturable absorber 600 is amplified at the optical amplifier 610. Furthermore, the modulated input optical signal having the wavelength λₛ is finally eliminated using the filter 620, and thus only the modulated optical signal having the wavelength λ_{c} is outputted (see FIG. 7F).

On the other hand, as described above, it is possible to obtain the output optical signal having the substantially constant power regardless of variation of the input optical power, by adjusting the transparent output optical power of the saturable absorber into the power higher than the saturation input optical power of the optical amplifier.

It is natural that the configuration is applicable also when the continuous wave signal having the wavelength λ_{c} and the optical signal having the wavelength λₛ are counter-propagated.

In the above description, although the present invention has been described in detail using the specific embodiments, the present invention is not limited to the embodiments, but improvements and modifications can be made by the skilled in the art without departing from the spirit of the present invention.

According to the configurations of the present invention described above, it is possible to amplify the optical signal and eliminate the noise of the optical signal by integrating the saturable absorber and the semiconductor optical amplifier. Also, it is possible to increase the output optical power and the extinction ratio of the output optical signal and perform various functions of equalization of output power, wavelength converting, reshaping and reamplifying the optical signal.

Also, when the optical signal processing element according to the present invention is used as the wavelength converter, the input optical power dynamic range is relatively wide, and it is possible to easily perform the wavelength conversion.

What is claimed is:

1. An optical signal processing element, comprising:
a first saturable absorber of which an passing power is more than a absorbed power thereof if an input optical signal having a power higher than a transparent input optical power is inputted, and of which the absorbed power is more than the passing power thereof if an input optical signal having a power lower than the transparent input optical power is inputted; and
an optical amplifier connected in series to the first saturable absorber and exhibiting an optical saturation when a power is higher than a saturation input optical power;
wherein a transparent output optical power outputted from the first absorber is not less than the saturation input optical power.

2. An optical signal processing element according to claim 1, further comprising a second saturable absorber connected to an output terminal of the optical amplifier.

3. An optical signal processing element according to claim 2, wherein the transparent input optical power of the first saturable absorber is not less than a transparent input optical power of the second saturable absorber.

4. An optical signal processing element according to claim 1, wherein the first saturable absorber and the optical amplifier are formed on a substrate, the element further comprising:
the substrate;
a first cladding layer formed on the substrate;
an active layer formed on the first cladding layer;
a second cladding layer formed on the active layer;
dielectrics formed on both facets;
an upper electrode formed on an upper surface above the first cladding layer, the second cladding layer and the active layer; and
a lower electrode formed on a lower surface below the first cladding layer, the second cladding layer and the active layer;
wherein, the upper electrode is divided correspondingly to the first saturable absorber and the optical amplifier, and the lower electrode is formed in a body, to connect the first saturable absorber and the optical amplifier in series.

5. An optical signal processing element according to claim 4, wherein the active layer comprised InGaAsP group triple layers including a fist layer made of a quaternary compound of 1.24 μm bandgap, a second layer made of a quaternary compound of 1.55 μm bandgap and formed on the first layer and a third layer made of a quaternary compound of 1.24 μm bandgap and formed on the second layer.

6. An optical signal processing element according to claim 1, further comprising a filter at an output end of the optical amplifier,
wherein the total power of the optical signal and a continuous wave signal having a desired wavelength less than the transparent input optical power is not less than the transparent input optical power, and
wherein the filter selects a wavelength of a desired wavelength.
